(19) United States
(12) Patent Application Publication
(10) Pub. No.: US 2005/0224191 A1
(43) Pub. Date: Oct. 13, 2005

(54) Balance-adjustable bottom rail for window blind

(75) Inventor: Ming Nien, Changhua Hsien (TW)

Correspondence Address: BIRCH STEWART KOLASCH & BIRCH, PO BOX 747, FALLS CHURCH, VA, 22040-0747, US

(73) Assignee: NIEN MADE ENTERPRISE CO., LTD

(21) Appl. No.: 10/896,874

(22) Filed: Jul. 23, 2004

(30) Foreign Application Priority Data
Apr. 12, 2004 (TW) 093205590

(51) Int. Cl. B60P 7/02

(52) U.S. Cl. 160/173 R

(57) ABSTRACT

A balance-adjustable bottom rail for a window blind is constructed to include an elongated hollow rail body having a longitudinal axis, a weight mounted inside the rail body and movable along the longitudinal axis of the rail body for adjusting the center of gravity of the rail body, and a positioning device for locking the weight to the rail body.

### BACKGROUND OF THE INVENTION

1. Field of the Invention

The present invention relates to a window blind and more specifically, to a balance-adjustable bottom rail for use in a lifting type window blind.

2. Description of the Related Art

A conventional lifting type window blind, for example, a roller blind comprises a roller pivotally provided at the top side of the window, a bottom rail arranged in parallel to and below the roller, and a blind shade coupled between the roller and the bottom rail. Rotating the roller (by hand or a reversible motor) cause the roller to roll up the blind.

As indicated, the bottom rail is suspended from the roller by the blind shade. Ideally, the bottom rail ought to be maintained horizontally in perfect balance, but in practice it is almost impossible. Due to the effect of the material itself, it is difficult to keep the tensile force of the blind shade in balance. During fabrication or installation of the bottom rail, it is difficult to control even distribution of the gravity weight. These factors may cause the suspended bottom rail to slope in one direction, thereby obstructing the sense of beauty of the window blind. Further, the sloping bottom rail imparts an unbalanced drag force to the bottom side of the blind shade. When rotating the roller to roll up the blind shade at this time, the blind shade will be received to the periphery of the roller in a wrinkled status. After a long use of the roller blind, the wrinkles exhibit in the blind shade in a permanent manner.

### SUMMARY OF THE INVENTION

It is the main objective of the present invention to provide a balance-adjustable bottom rail for a window blind, which can be conveniently adjusted to a balanced status.

It is another objective of the present invention to provide a balance-adjustable bottom rail for a window blind, which maintains the nice looking of the window blind in a smooth status.

To achieve these objectives of the present invention, the balance-adjustable bottom rail for a window blind comprises an elongated hollow rail body having a longitudinal axis, a weight mounted inside the rail body and movable along the longitudinal axis of the rail body for adjusting the center of gravity of the rail body, and a positioning device for locking the weight to the rail body.

### BRIEF DESCRIPTION OF THE DRAWINGS

FIG. 1 is a perspective view of a balance-adjustable bottom rail according to a first preferred embodiment of the present invention.

FIG. 2 is an exploded view of the balance-adjustable bottom rail according to the first preferred embodiment of the present invention.

FIG. 3 is a top view in an enlarge scale of a part of the balance-adjustable bottom rail according to the first preferred embodiment of the present invention.

FIG. 4 is a sectional view taken along line 4-4 of FIG. 3.

FIG. 5 is similar to FIG. 4 but showing that a button of the positioning device is pressed.

FIG. 6 is an applied view of the first preferred embodiment of the present invention, showing the balance-adjustable bottom rail used in a roller blind.

FIG. 7 is a perspective view of a balance-adjustable bottom rail according to the second preferred embodiment of the present invention.

FIG. 8 is an exploded view of the balance-adjustable bottom rail according to the second preferred embodiment of the present invention.

FIG. 9 is an exploded view of a part of the second preferred embodiment of the present invention, showing the relationship between the button, the steel ball, and the spring member.

FIG. 10 is a top view in an enlarged scale of a part of the balance-adjustable bottom rail according to the second preferred embodiment of the present invention.

FIG. 11 is a sectional view taken along line 11-11 of FIG. 10.

### DETAILED DESCRIPTION OF THE INVENTION

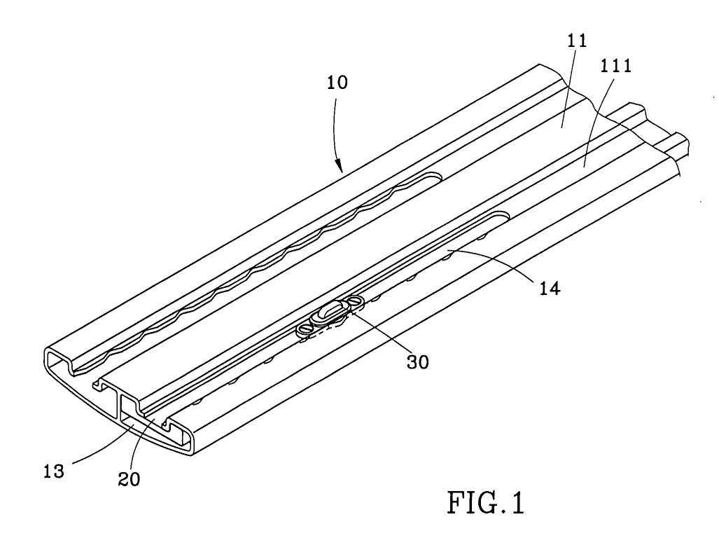

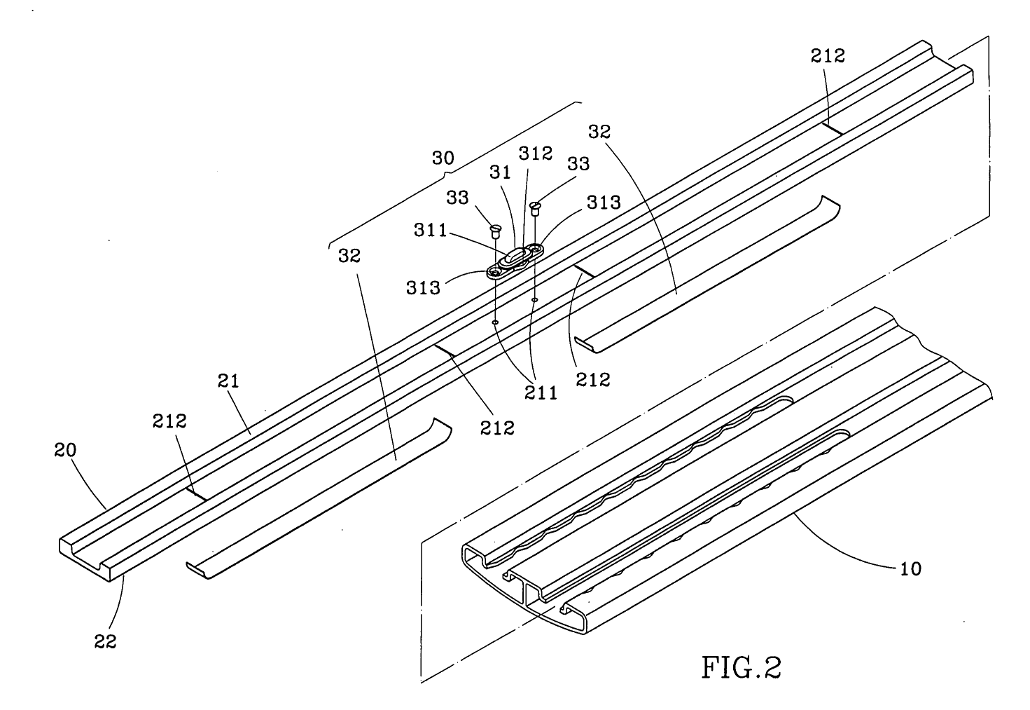

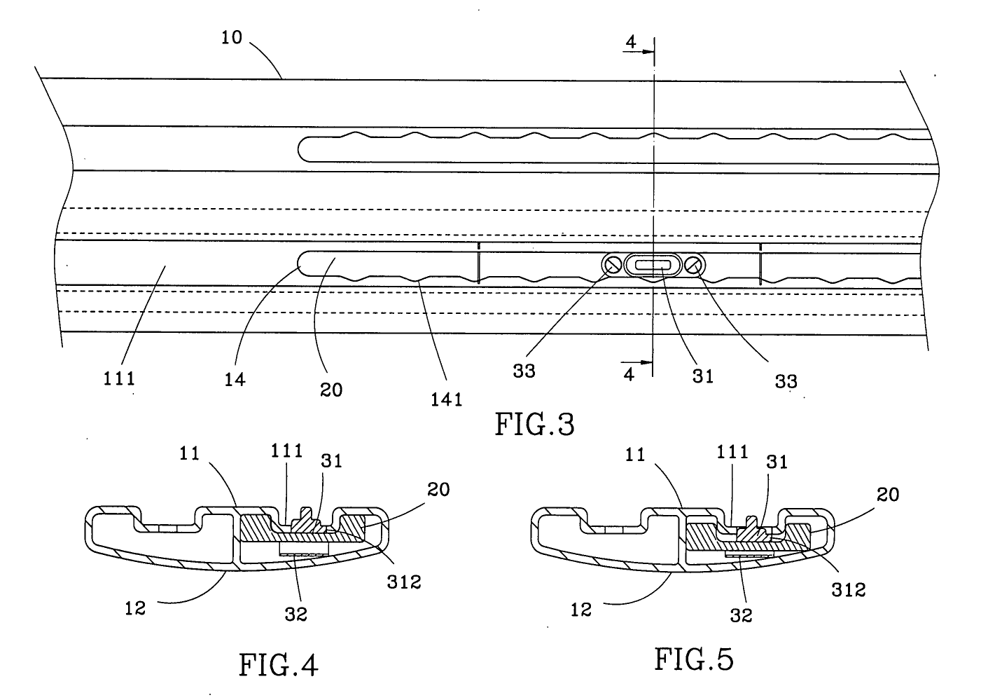

Referring to FIGS. 1-5, a balance-adjustable bottom rail for a window blind in accordance with the first preferred embodiment of the present invention is shown comprised of a rail body 10, a weight 20, and a positioning device 30.

The rail body 10 is a flat elongated hollow member having a longitudinal axis parallel to a long side thereof, a top wall 11, a bottom wall 12 transversely curved outwards, two longitudinal grooves 111 formed in the top wall 11 and extended along the longitudinal side of the rail body 10, two receiving chambers 13 defined in between the top wall 11 and the bottom wall 12, two longitudinal sliding slots 14 cut respectively through the top wall 11 in communication between the receiving chambers 13 and the longitudinal grooves 111, and a serrated engagement portion 141 arranged along one long side of each longitudinal sliding slot 14.

The weight 20 is a narrow elongated heavy member inserted into one receiving chamber 13 of the rail body 10 and fitting the periphery of one longitudinal groove 111 of the rail body 10, having a top wall 21 fitting the top wall of the respective receiving chamber 13, a flat bottom wall 22, two screw holes 211 extended through the top wall 21 and the bottom wall 22 around the middle area, and a plurality of plugholes 212 extended through the top wall 21 and the bottom wall 22 and symmetrically disposed at two sides relative to the screw holes 211.

The positioning device 30 is comprised of a button 31, two spring plates 32, and two screw bolts 33. The button 31 comprises a finger knob 311 at the top, an engagement member, i.e. a tooth 312, protruded from one lateral side for engaging the serrated engagement portion 141 at one long side of one longitudinal sliding slot 14 of the rail body 10, and two mounting through holes 313 near the two distal ends corresponding to the screw holes 211 of the weight 20. The two screw bolts 33 are respectively mounted in the mounting through holes 313 and threaded into the screw holes 211 to affix the button 31 to the top wall 21 of the weight 20. The two spring plates 32 are narrow elongated curved spring members having two upright ends respectively fastened to the plugholes 212 of the weight 20 such that the spring plates 32 are symmetrically bilaterally suspended from the bottom wall 22 of the weight 20 in an arched shape. The spring plates 32 are inserted with the weight 20 into one receiving chamber 13 of the rail body 10. After insertion of the spring plates 32 with the weight 20 into one receiving chamber 13 of the rail body 10, the arched spring plates 32 are stopped against the bottom wall of the respective receiving chamber 13 to force the top wall 21 of the weight 20 against the top wall of the respective receiving chamber 13. At this time, the finger knob 311 protrudes over the top wall 11 of the rail body 10 through the respective longitudinal sliding slot 14 and the tooth 312 is meshed with the serrated engagement portion 141 at one side of the respective longitudinal sliding slot 14.

When wishing to adjust balancing of the balance-adjustable bottom rail, press the finger knob 311 of the button 31 to disengage the tooth 312 of the button 31 from the respective serrated engagement portion 141 of the rail body 10 (see FIG. 5), and then hold the button 31 in the pressed status and push the button 31 to move the weight 20 along the respective longitudinal sliding slot 14, thereby adjusting the center of gravity of the rail body 10. When adjusted, release the hand from the button 31. At this time, the spring plates 32 force the weight 20 and the button 31 upwards, and therefore the tooth 312 of the button 31 is forced into engagement with the respective serrated engagement portion 141 again to fix the weight 20 in position.

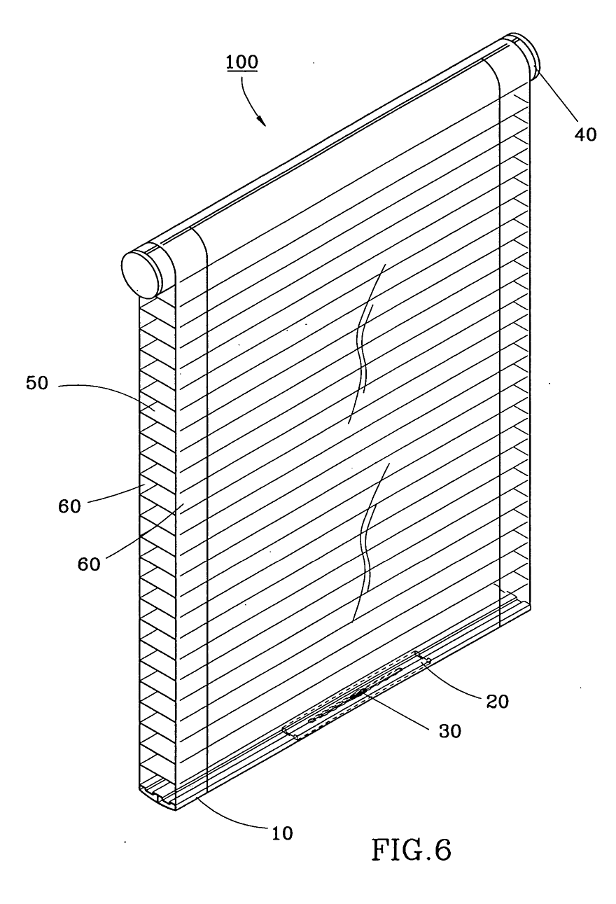

FIG. 6 shows an application example of the first embodiment of the present invention in a roller blind 100. As illustrated, the roller blind 100 comprises a roller 40 horizontally pivotally provided at the top side of a window (not shown), a rail body 10 spaced below the roller 40, a plurality of flexible slats 50 arranged in parallel between the roller 40 and the rail body 10, two fabric shades 60 covering the flexible slats 50 at two sides and respectively connected between the roller 40 and the rail body 10 of the balance-adjustable bottom rail. If the tensile force of each fabric shade 60 is not in balance, operate the button 30 to adjust the position of the weight 20 in the rail body 10 to further adjust the center of gravity of the balance-adjustable bottom rail, keeping the rail body 10 in horizontal perfectly.

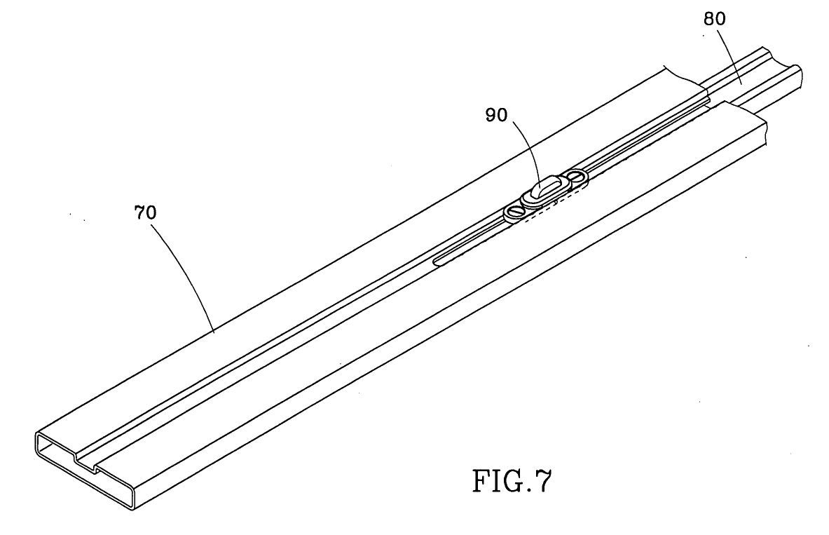

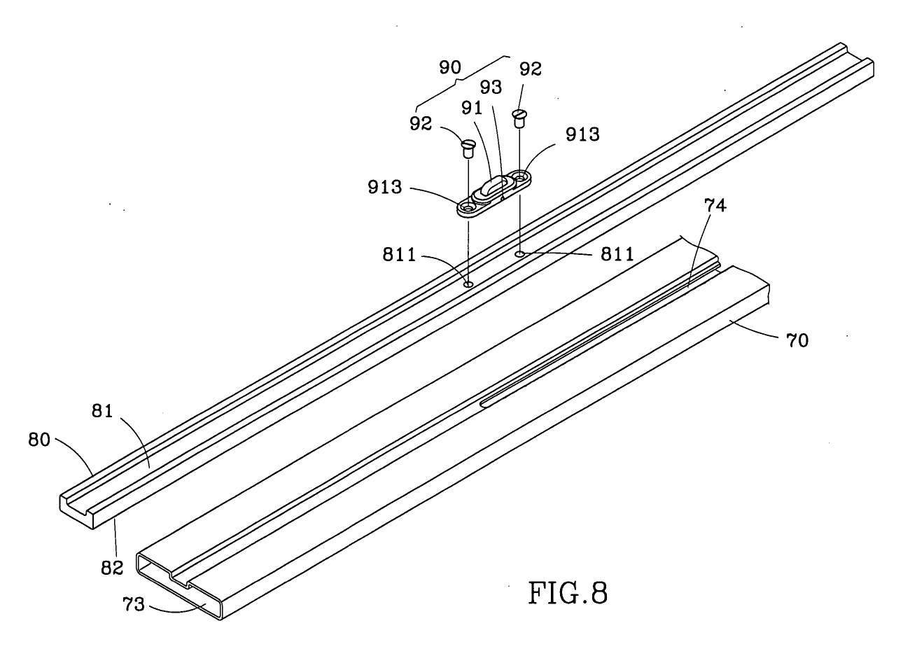

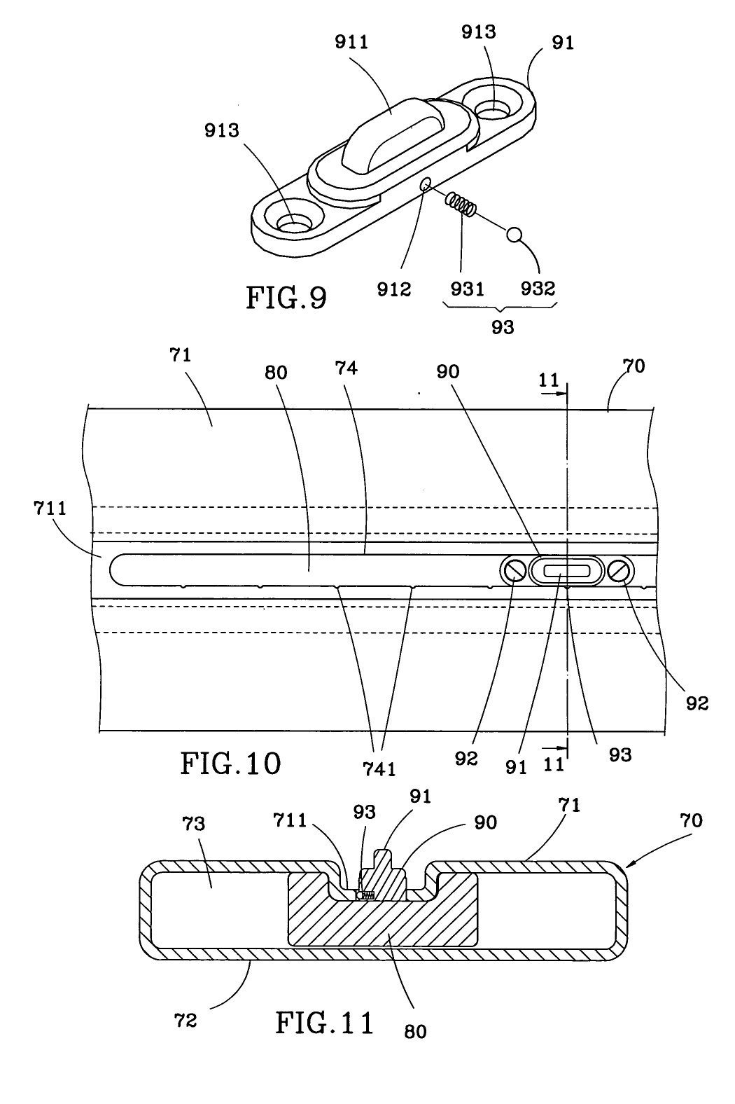

FIGS. 7-11 show a balance-adjustable bottom rail constructed according to the second preferred embodiment of the present invention. According to this embodiment, the balance-adjustable bottom rail is comprised of a rail body 70, a weight 80, and a positioning device 90.

The rail body 70 is a flat elongated hollow member having a top wall 71, a flat bottom wall 72, a longitudinal groove 711 formed in the top wall 71 and longitudinally extended to the two distal ends of the top wall 71, a receiving chamber 73 defined in between the top wall 71 and the bottom wall 72, a longitudinal sliding slot 74 cut through the top wall 71 in communication between the receiving chamber 73 and the longitudinal groove 711, and a serrated engagement portion (longitudinal series of notches) 741 arranged along one long side of the longitudinal sliding slot 74.

The weight 80 is a narrow elongated longitudinally grooved heavy member inserted into the receiving chamber 73 of the rail body 70, having a top wall 81 fitting the top wall of the respective receiving chamber 73, a flat bottom wall 82, and two screw holes 811 extended through the top wall 81 and the bottom wall 62 around the middle area.

The positioning device 90 is comprised of a button 91, two screw bolts 92, and an engagement member 93. The button 91 comprises a finger knob 911 at the top, a recessed hole 912 in one lateral side, and two mounting through holes 913 near the two distal ends. The screw bolts 92 are respectively mounted in the mounting through holes 913 and threaded into the screw holes 811 to fix the button 91 to the top wall 81 of the weight 80. The engagement device 93 comprises a compression spring 931 mounted in the recessed hole 912 of the button 91, and a steel ball 932 supported on the compression spring 931. After insertion of the weight 80 into the receiving chamber 73 of the rail body 70, the top wall 81 and bottom wall 82 of the weight 80 are set in contact with the top and bottom wall of the receiving chamber 73 respectively, and the steel ball 932 is forced outwards by the compression spring 931 into engagement with the serrated engagement portion 741 at one long side of the longitudinal sliding slot 74. When wishing to adjust the center of gravity of the balance-adjustable bottom rail, push the button 91 to move the weight 80 in the receiving chamber 73 along the longitudinal sliding slot 74. When released the hand from the button 91 after adjustment, the steel ball 932 is forced by the compression spring 931 to engage the serrated engagement portion 741, thereby locking the weight 80 to the weight in the adjusted position.

Although particularly embodiments of the present invention have been described in detail for purposes of illustration, various modifications and enhancements may be made without departing from the spirit and scope of the invention. Accordingly, the invention is not to be limited except as by the appended claims.

1. A bottom rail for a window blind, said bottom rail comprising:
an elongated rail body having a longitudinal axis;
a weight mounted inside said rail body and movable along the longitudinal axis of said rail body for adjusting the center of gravity of said rail body; and
a positioning device for locking said weight to said rail body.

2. The bottom rail as claimed in claim 1, wherein said rail body is a hollow body having a top wall, a bottom wall, and a receiving chamber defined in between said top wall and said bottom wall for accommodating said weight.

3. The bottom rail as claimed in claim 2, wherein said receiving chamber having a top wall and a bottom wall; said weight has a top wall fitting the top wall of said receiving chamber in profile.

4. The bottom rail as claimed in claim 3, wherein said rail body comprises a longitudinal groove formed in the top wall of the rail body and extended along the longitudinal axis of said rail body; said weight is channeled to fit a periphery of longitudinal groove of said rail body.

5. The bottom rail as claimed in claim 1, wherein said rail body comprises a longitudinal groove formed in the top wall thereof and extended along the longitudinal axis of said rail body; said positioning device has a part exposed on said longitudinal groove.

6. The bottom rail as claimed in claim 1, wherein said rail body comprises a plurality of engagement portions; said positioning device comprises an engagement member for engaging the engagement portions of said rail body to further lock said weight to said rail body.

7. The bottom rail as claimed in claim 6, wherein said positioning device comprises a button mounted on said weight, said button having a finger knob exposed to the outside of said rail body, and a smoothly arched spring plate having two ends connected to a bottom said of said weight.

8. The bottom rail as claimed in claim 6, wherein said rail body is a hollow body having a top wall, a bottom wall, and a receiving chamber defined in between said top wall and said bottom wall for accommodating said weight; wherein said rail body further comprises a longitudinal sliding slot cut through the top wall of said rail body in communication with said receiving chamber; wherein said engagement portions of said rail body are arranged along one long side of said longitudinal sliding slot and formed of a longitudinal series of equally spaced notches.

9. The bottom rail as claimed in claim 6, wherein said positioning device comprises a button mounted on said weight.

10. The bottom rail as claimed in claim 9, wherein said engagement member of said positioning device comprises a recessed hole formed in one lateral side thereof, a spring member mounted in said recessed hole of said button, and a steel ball supported on said spring member.
